(19) United States
(12) Patent Application Publication
(10) Pub. No.: US 2003/0023972 A1
(43) Pub. Date: Jan. 30, 2003

(54) Method for charging advertisers based on adaptive commercial switching between TV channels

(75) Inventors: Srinivas Gutta, Buchanan, NY (US); Miroslav Trajkovic, Ossining, NY (US); Kaushal Kurapati, Yorktown Heights, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 09/915,683

(22) Filed: Jul. 26, 2001

(51) Int. Cl. H04N 7/025; H04N 7/10

(52) U.S. Cl. 725/34; 725/32; 725/36

(57) ABSTRACT

Disclosed is a method and system for switching a commercial for a user. Accordingly, the present invention obtains a user's profile or monitors a user's viewing history of various commercials to determine the type of commercials that are not watched or not liked by the user. Thereafter, commercials between television programs are detected during a commercial break and compared with the user's profile or the user's past viewing information to determine whether the detected commercial is liked by the user. For an unwanted commercial, the present system retrieves one of the commercials liked by the user that is shown on different channels, then replaces the unwanted commercial with the commercial that is of interest to the user

### BACKGROUND OF THE INVENTION

1. Field of the Invention

The present invention relates to a commercial switching system, particularly, to a method and system for filtering unwanted commercials by television viewers according to a user's criteria.

2. Description of the Invention

From an advertiser's perspective the ability to target advertisements that are relevant to the consumer can be beneficial, without annoying the television viewers. Typically, an average of 4-5 commercials are shown between program breaks. However, not all commercials that are broadcast on a particular channel match a particular viewer's taste or lifestyle. If a viewer does not like a commercial, he or she will either tune to another channel or mute the current channel. To advertisers, this type of behavior, in essence, is a loss of revenue for the company.

Most advertising revenue collection schemes are straightforward. If a television show is anticipated to generate immense public attention, the ad-time costs surrounding that show are high. Thus, based on the type of TV-show and the duration of the broadcast, advertisers pay different costs to advertise their products and services. In this type of advertising, the advertiser can only assume a general target audience for the advertisements but can not assure that the entire audience will be interested in the product/service. Accordingly, there is a need to have a system that can automatically provide relevant commercials to the television viewers in real time during a television broadcast.

### SUMMARY OF THE INVENTION

The present invention provides a method and system for switching commercials according to predetermined data representative of commercials liked by a user or a user's past commercial viewing history.

Accordingly, the present invention relates to a method for switching a commercial for a user and includes the steps of: obtaining a viewing history or user profile for the user; analyzing incoming television programs to detect the beginning and ending positions of each commercial between the television programs; comparing the detected commercial to the viewing history to determine whether the detected commercial is liked by the user; and, switching with another commercial if the the user dislikes the detected commercial.

Furthermore, the present invention relates to a system for switching a commercial for a user. It includes a fist storage means for storing data representative of a plurality of commercials liked by the user; a detection means for detecting the beginning and ending of each commercial between the television programs; a second storage means for storing a plurality of pre-recorded commercials liked by the user from a plurality of television channels; and, a controlling means for determining whether the detected commercial in a particular channel is liked by said user according to the data stored in the first storage means.

### BRIEF DESCRIPTION OF THE DRAWINGS

A more complete understanding of the method and apparatus of the present invention is available by reference to the following detailed description when taken in conjunction with the accompanying drawings wherein:

FIG. 1 illustrates a commercial switching system in accordance with the present invention;

FIG. 2 illustrates a sample list of closed captioning a television program in accordance with the present invention;

FIG. 3(a) is a flow chart illustrating the process of determining the beginning and end of a commercial in accordance with the present invention;

FIG. 3(b) is a flow chart illustrating the commercial switching steps in accordance with the present invention;

FIG. 4 is a sample timing chart illustrating the detection of commercials during a television program in accordance with the present invention; and,

FIG. 5 is a sample timing chart illustrating the detection of different commercials between a commercial break in accordance with the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments that depart from these specific details. For the purpose of simplicity and clarity, detailed descriptions of well-known devices, circuits, and methods are omitted so as not to obscure the description of the present invention with unnecessary detail.

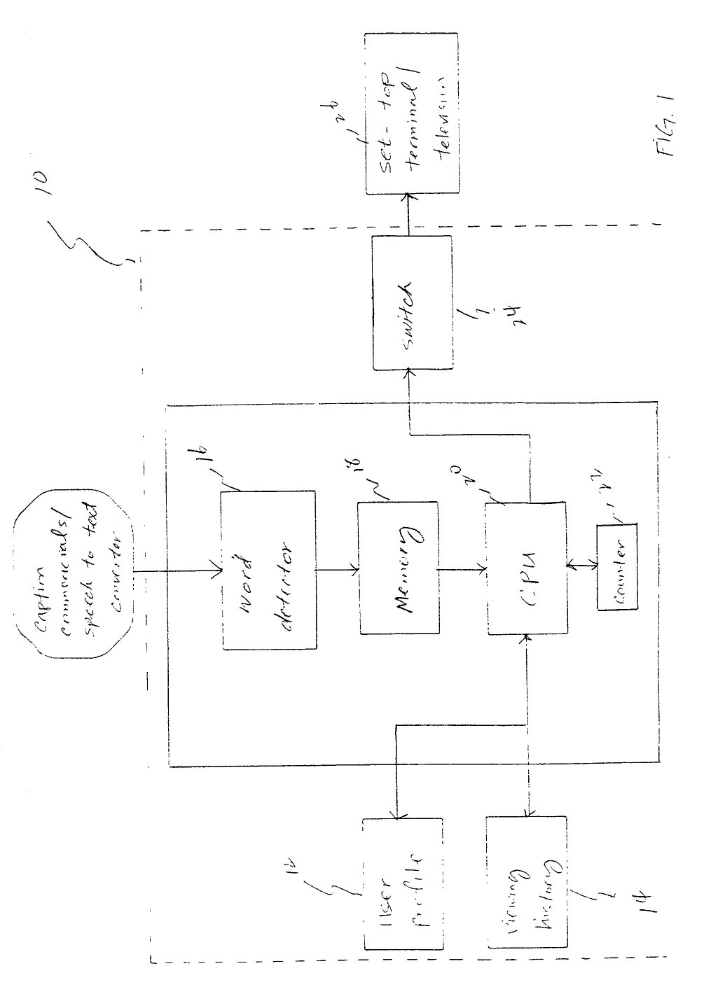

FIG. 1 illustrates a commercial switching system 10 capable of exchanging unwanted commercials based on the viewer's preference according to an exemplary embodiment of the present invention. The inventive system 10 detects incoming television commercials and determines whether a particular commercial satisfies a user's criteria, then discriminates unwanted commercials by replacing them with the commercials shown on different channels that satisfy the user's criteria. Alternatively, the inventive system 10 monitors the viewing history of a particular viewer and determines the type of commercials that are watched and not watched by the viewer; then, during a commercial break, the unwanted commercials are replaced by other commercials of interest according to the past viewing history. In addition, the inventive system 10 provides a payment mechanism for broadcasters to charge advertisers more for their advertisements in the event that an option for switching commercial, as described in the preceding paragraphs, is requested.

Referring to FIG. 1, the inventive system 10 may be embodied as any computing device, such as a personal computer or workstation that contains a processor, such as a central processing unit (CPU), and a memory, such as RAM and ROM. As shown in FIG. 1, major components of the inventive system 10 that enable the replacement of unwanted commercials includes a user profile 12, a viewing history section 14, a word detector 16, a memory 18, a CPU 20, a counter 22, and a switch circuit 24. The inventive system 10 processes and generates data representative of a plurality of commercials preferred by a given user. To generate a database for the user profile 12, a suitable interface exists between the user and the inventive system 10 to gather user's rating for the type of commercials he or she wishes to skip. For example, if the user wants to receive an automobile advertisement during a normal commercial break, the user can give “car” as a query or a model name, i.e., “Honda Accord”, as a query in the user profile 12. In addition, if the user is further interested in other commercials related to car commercials, i.e., loans, auto insurance, mechanic shops, etc., the user can specify these types of commercials by listing a plurality of key words associated with the commercials in the user profile 12. Similarly, the inventive system 10 can build a viewing history of a given user to determine the type of commercials preferred by the user, by observing the user's commercial viewing habits over time and generalizing the user's viewing habits to build a database that is similar to the user profile 12. Thus, based on the user's viewing pattern, a database reflecting the user's likes or dislikes of various commercials can be obtained. Furthermore, it is noted that the results of processing the user viewing history 14 can be stored in the form of updates to the user profile 12.

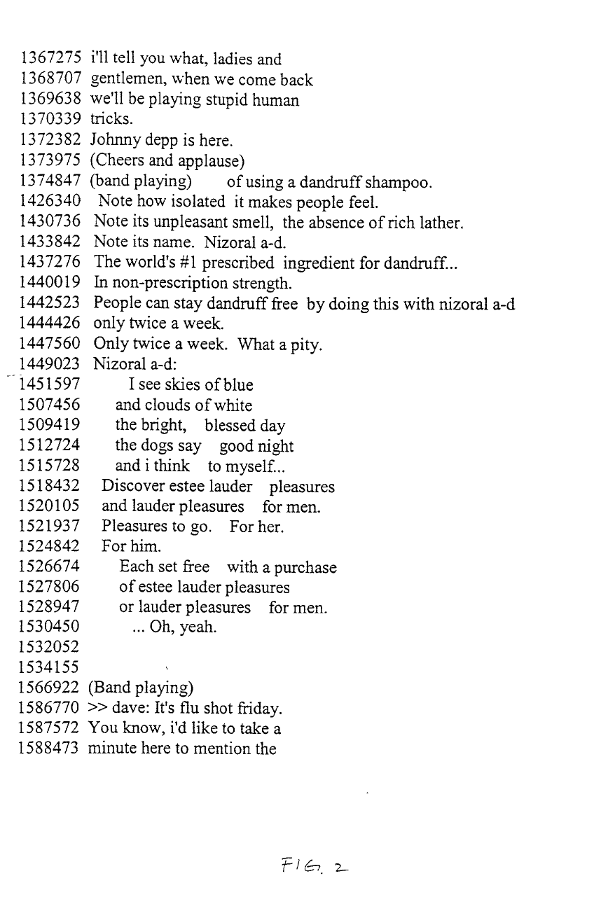

Now, a detailed description of detecting and determining whether the commercial in the current channel is broadcasting an unwanted commercial will be explained hereinafter with reference to FIG. 2 through FIG. 5.

In operation, the CPU 20 causes the word detector 16 to extract closed captioning data from incoming broadcast stream. As an illustrative example, FIG. 2 represents a portion of the closed captioning extracted from “The Late Night Show with David Letterman” along with a time stamp indicated thereon. It should be noted that not all commercials are closed captioned. In such a case, the incoming video programs are converted to generate transcripts using a speech-to-text converter that is well known in the art. Once the closed captioning data is obtained, the present invention provides a mechanism to identify the commercial region as well as individual commercials that make up the commercial area. To achieve this, the CPU 20 causes the counter 22 to count the frequency of key words within multiple commercial segments in order to detect the beginning and ending of different commercials and to detect the content of the detected commercials (explained later). At the same time, the CPU 20 processes the information stored in the user profile 12, if available, and/or the user's viewing history 14 to determine whether to swap the commercial in the current channel with another commercial broadcast at different channels. If the commercial received in the current channel is determined to be an unwanted commercial based on the user's profile 12 and/or past viewing history 14, the CPU 20 retrieves another commercial that satisfies the user's profile 12 and/or the viewing history 14 from the memory 18, which contains a database of all commercials being broadcast on different channels, then swaps the commercial using the switch circuit 24. The output signals of the switch circuit 24 is then forwarded to a conventional set-top terminal or television unit 26 for display.

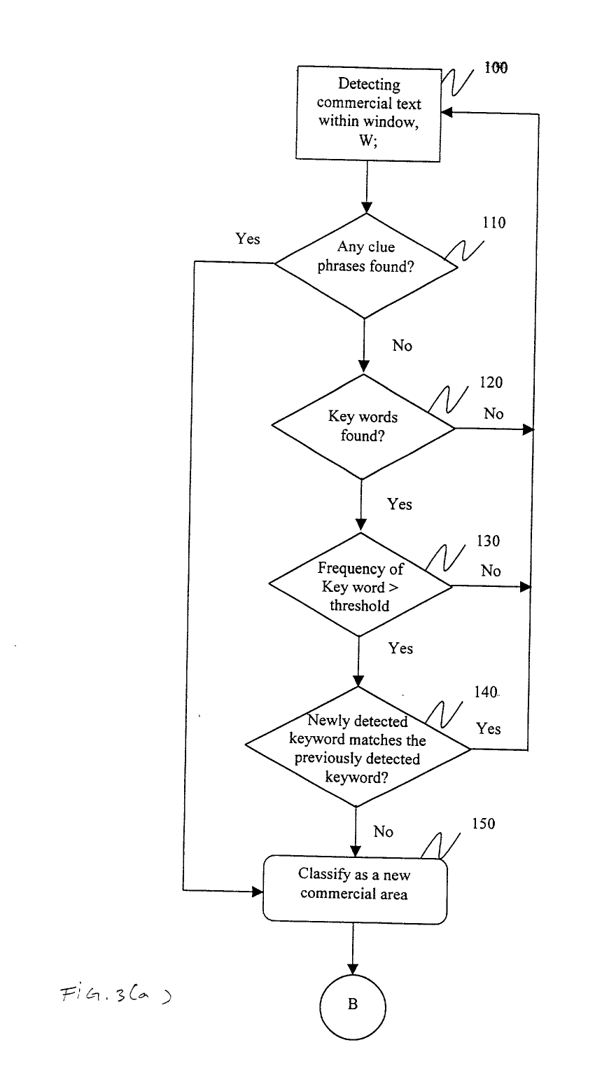

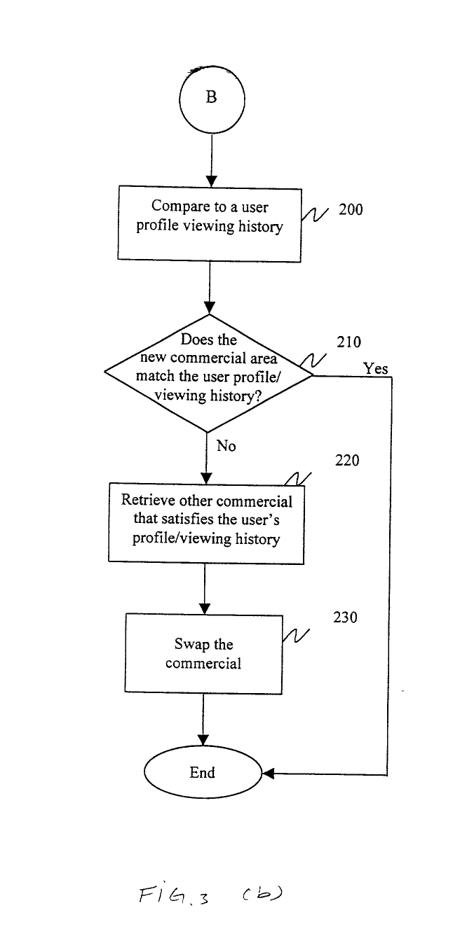

A description of detecting the beginning and ending of commercials and classifying the content of the detected commercials according to the embodiment of the present invention is explained hereinafter. It should be noted that the chosen embodiment of the present invention is a computer software executing within a computer system. Computer programs (or computer control logic) are stored in the main memory. Such computer programs, when executed, enable the computer system to perform the function of the present invention. The illustrative programmed instructions for detecting and switching an incoming commercial according to predetermined criteria are shown in FIGS. 3(a) and 3(b), and described below.

Referring to FIG. 3(a), a detection of commercials including the beginning and ending of commercials between television programs is performed initially in step 100. To achieve the detection, closed captioning corresponding to the incoming broadcast stream is extracted, as shown in FIG. 3. If the incoming commercial does not contain the corresponding closed-captioned data, the incoming video programs are converted to generate transcripts using any well known speech-to-text converter.

Once the text data is retrieved, the process of segmenting incoming television programs to detect the beginning and end of different commercials is performed. Initially, as programs such as news and talk shows contain some phrases that are “commercial aware” cues, i.e., “when we come back,” “still ahead,” “up next,” etc., it is determined whether these types of phrases are detected in the incoming closed captioning in step 110. If they are detected, these phrases can be used to identify the beginning of commercial areas. For example, as shown in FIG. 3, the time stamp 1368707 includes the phrase “when we come back,” which acts as a cue that a commercial section is beginning.

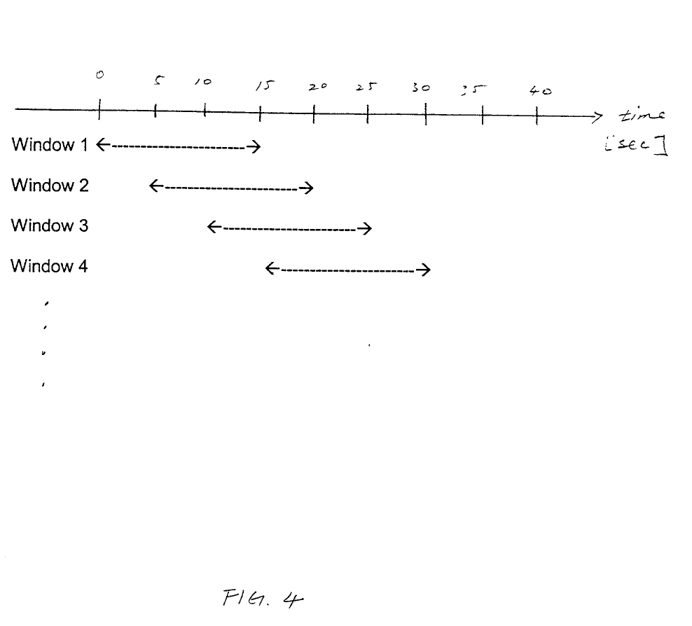

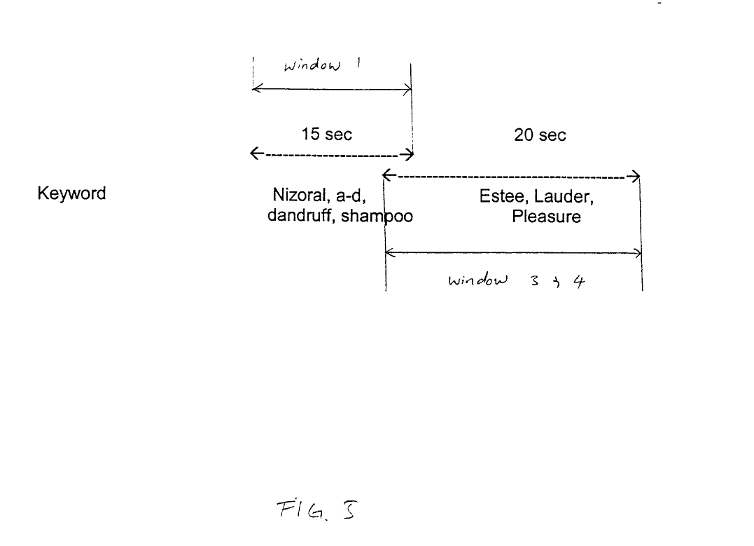

Thereafter, in step 120, it is determined whether any key words are detected in the time-based map of closed captioning containing a plurality of text lines/entries, as shown in FIG. 2. Here, the key words represent common words that appear most frequently in the text lines and tend to reflect the content of a given commercial. Accordingly, in the embodiment, the detected key words are used to compare with the prerecorded data in query format that is stored in the user profile 12 and the viewer's history 14. To accomplish this, the CPU 20 causes the counter 22 to count the frequency of the occurrence of the “non-stop” (words other than “an”, “the”, “of”, etc.) words that occur within a series of predetermined time period, i.e., 15 seconds, which represents a typical duration of a commercial. If one or more key words occur more than twice within each predetermined time interval, then the corresponding segment is determined to be a possible commercial segment. The word counts are generated for overlapping time periods. That is, as shown in FIG. 4, a multiple of overlapping time window periods is used to count the frequency of words within a given program. For example, a first window period between 0-15 seconds, a second window period between 5-20 seconds, a third window period between 10-25 seconds, and a forth window period between 15-30 seconds are applied to the text shown in FIG. 3 to detect common words or key words within the respective time period. In this example, there is an overlap of ten seconds in the time window. Thus, there are counters for the first fifteen seconds, another set of counters for the last ten seconds of this window and the following five seconds. Referring to FIG. 5, the first 15 seconds of the first window (starting from time 1374847 to 1449023) contains the keywords, Nizoral, a-d, dandruff, shampoo, while the window 3 and 4 (starting from time 1518432 to 1528947) contains the keywords, Estee, Lauder, and Pleasure. Therefore, it can be determined that the duration of the first window frame represents a possibly different commercial as the duration of the third and forth window frames. Thereafter, the beginning and ending positions of possible commercial segments and the corresponding key words are temporarily stored in a probable commercial list for further analysis. If no key word is found in step 120 within a current window period, the step returns to step 100 to detect the next window period.

In step 130, the data in the probable commercial list is analyzed by comparing the detected frequency of the key words to a predetermined threshold value of, for example 2. If the detected frequency of the key words exceeds the threshold value, in step 140, the content of the current key words detected in step 120 is compared to the keywords from the previous window segment. That is, the words that occur more than a preset threshold (2 in this example) are stored and compared to the words that occurred in the previous windows. If they match, this window is identified as a new commercial area in step 150. It should be noted that most commercials are rarely over a minute long. Hence, the total time period should be set to some limit so that we do not store a whole show due to the repetition of certain words or names. Hence, no more than 12 overlapping windows should be grouped together as one possible commercial.

Referring to FIG. 2(b), once the beginning and ending of different commercials have been detected, as described in the preceding paragraphs, the corresponding key words are stored. Then, the key words of the detected commercials are compared to the data stored in the user profile 12 and/or viewing history 14 in step 200. The information stored in the user profile 12 and the viewing history section 14 are compared to determined whether a particular commercial is liked by the user in step 210. If not satisfied, other commercials that match the data stored in the user profile 12 or the past viewing history 12 are retrieved from the memory 18 in step 220. The memory 18 contains a plurality of commercials that are shown on all different channels. In the embodiment, the plurality of commercials shown on different channels are detected by executing the same steps described in FIG. 3(a) and stored in the memory 18. Finally, if the advertisers have elected to pay additional money to the broadcaster for commercial-switching feature, the unwanted commercial is replaced by the commercial preferred by the user. Under this commercial-switching scheme, the advertisers'advertisements will run on many more channels and their “hit-rate” is much higher compared to the old/traditional form of TV-advertising.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt to a particular situation and the teaching of the present invention without departing from the central scope. Therefore, it is intended that the present invention not be limited to the particular embodiment disclosed as the best mode contemplated for carrying out the present invention, but that the present invention includes all embodiments falling within the scope of the appended claims.

What is claimed is:

1. A method for switching a commercial for a user, the method comprising the steps of:
obtaining a user profile indicating television commercials preferred by said user;
analyzing incoming television programs in a channel viewed by said user to detect the beginning and ending positions of each commercial between said television programs;
comparing said detected commercial to said user profile to determine whether said detected commercial is desired by said user;
retrieving a replacement commercial preferred by said user from a storage means if said detected commercial is not like by said user; and,
switching said detected commercial with said replacement commercial.

2. The method of claim 1, wherein said analyzing step further includes the steps of:
detecting a frequency of key words that appeared within a predetermined time period;
comparing said detected frequency to a threshold value; and,
classifying as the beginning and ending of a new commercial if said detected frequency exceeds a threshold value.

3. The method of claim 1, wherein said analyzing step further comprising the step of converting the video signals of said incoming television programs into a time-based map of closed captioning data.

4. The method of claim 1, further comprising the step of storing a plurality of prerecorded commercials liked by said user from a plurality of television channels in said storage means.

5. The method of claim 1, further comprising the step of storing said profile data in a user profile storage means.

6. The method of claim 1, wherein said user profile obtaining step further comprises the step of interactively creating said user profile in advance of said analysis step of said television programs.

7. The method of claim 1, further comprising the step of selectively imposing an additional advertisement charge if said switching step is performed.

8. A method for switching a commercial for a user, the method comprising the steps of:
obtaining a viewing history for said user;
analyzing incoming television programs in a channel viewed by said user to detect the beginning and ending positions of each commercial between said television programs;
comparing said detected commercial to said viewing history to determine whether said detected commercial is liked by said user;
retrieving a replacement commercial liked by said user from a storage means if said detected commercial is not liked by said user; and,
switching said detected commercial with said replacement commercial.

9. The method of claim 8, wherein said viewing history obtaining step comprises the steps of:
monitoring data representative of a plurality of commercials watched by said user for a predetermined time period;
analyzing the data to classify said plurality of commercials into a preference map of commercials mostly watched by said user; and,
storing said preference map in said storage means.

10. The method of claim 8, wherein said analyzing step further comprising the step of converting the video signals of said incoming television programs into a time-based map of closed captioning data.

11. The method of claim 8, wherein said analyzing step further includes the steps of:
detecting the frequency of key words appearing within a predetermined time period;
comparing said detected frequency to a threshold value; and,
classifying as the beginning and ending of a new commercial if said detected frequency exceeds a threshold value.

12. The method of claim 8, further comprising the step of storing a plurality of pre-recorded commercials liked by said user from a plurality of television channels in said storage means.

13. The method of claim 8, further comprising the step of selectively imposing an additional advertisement charge if said switching step is performed.

14. A system for switching a commercial for a user, comprising:
a memory for storing a computer-readable code; and,
a processor operatively coupled to said memory, said processor configured to:
obtain data representative of television commercials liked by said user;
analyze incoming television programs in a channel viewed by said user to detect the beginning and ending positions of each commercial between said television programs;
compare said detected commercial to said user profile to determine whether said detected commercial is liked by said user;
retrieve a replacement commercial liked by said user from a storage means if said detected commercial is not liked by said user; and,
swap said detected commercial with said replacement commercial.

15. A system for switching a commercial for a user, comprising:
a first storage means for storing data representative of a plurality of commercials liked by said user;
a detection means, coupled to receive incoming television programs viewed by said user, for detecting the beginning and ending of each commercial in said television programs;
a second storage means for storing a plurality of pre-recorded commercials liked by said user from a plurality of television channels;
a controlling means, coupled to said first storage means, said detection means, and said second storage means for determining whether said detected commercial in a particular channel is liked by said user based on a comparison between said detected commercial and the data stored in said first storage means; and,
a switch means coupled to said controlling means for switching a commercial not liked by said user in a current channel with a pre-recorded commercial liked by said user from said second storage means.

16. The system of claim 15, further comprising a converting means for converting said incoming television programs into a time-based map of closed captioning data.

17. The system of claim 15, further comprising a display means for displaying the output signals of said switching means.

18. The method of claim 15, wherein the data representative of said plurality of commercials liked by said user is interactively created in advance.
